(19) United States
(12) Patent Application Publication
(10) Pub. No.: US 2023/0249425 A1
(43) Pub. Date: Aug. 10, 2023

(54) SCREW CONVEYOR FOR A SCREW SEPARATOR AND MANUFACTURING METHOD FOR A SCREW CONVEYOR

(71) Applicant: VOGELSANG GMBH & CO. KG, Essen (DE)

(72) Inventors: Peter Hartogh, Essen (DE); Hugo Vogelsang, Essen (DE)

(73) Assignee: VOGELSANG GMBH & CO. KG, Essen (DE)

(21) Appl. No.: 18/107,798

(22) Filed: Feb. 9, 2023

(30) Foreign Application Priority Data
Feb. 10, 2022 (DE) 202022100751.9

(51) Int. Cl. B30B 9/12; B23K 9/04; B23K 9/16

(52) U.S. Cl. CPC B30B 9/121; B23K 9/048; B23K 9/16; B33Y 80/00

(57) ABSTRACT

A screw conveyor comprises a shaft, a screw flight arranged to extend helically around, and connected to the shaft at the outer circumference of the shaft, and extending in axial direction along at least a portion of the shaft, wherein the screw flight has an outer edge at the outer circumference of the screw flight, and at least one recess for receiving fibrous material is arranged in the outer edge of the screw flight. The screw flight has a cross-sectional profile with a width in the region of the outer circumference of the screw flight greater than the width in the region of the inner circumference of the screw flight. Furthermore, the invention relates to a separator device for dewatering moist masses, including liquid manure residues and/or digestates, as well as a method for additively manufacturing a screw conveyor and a use of a screw conveyor.

### CROSS-REFERENCE TO FOREIGN PRIORITY APPLICATION

The present application claims the benefit under 35 U.S.C. §§ 119(b), 119(e), 120, and/or 365(c) of German Application No. DE 20 2022 100751.9 filed Feb. 10, 2022.

### FIELD OF THE INVENTION

The invention relates to a screw conveyor, in particular, for a separator device for dewatering moist masses, and a separator device for dewatering moist masses. Furthermore, the invention relates to a method for additive manufacturing of a screw conveyor and to a use of a screw conveyor in a separator device.

### BACKGROUND OF THE INVENTION

Screw conveyors are used in various fields for conveying different goods, for example, in screw conveyors or separator devices.

Separator devices with screw conveyors are used in particular for dewatering moist masses, for example, for dewatering of liquid manure or digestates. Such a separator device is known, for example, from DE 10 2006 052 669 A1. Here, the screw conveyor rotates in a cylinder screen and thereby presses the liquid portion of a mass to be dewatered through the cylinder screen. For an efficient filtration, a good contact of the circumference of the screw conveyor with the cylinder screen is desired for the purpose of sealing and screen cleaning. In order to avoid clogging of the screen openings, it is advantageous to have a cylinder screen with as thin a wall as possible. However, with screw separators of this design, wear occurs on the outer circumference of the screw flights and on the cylinder screen, which can lead to a drop in throughput.

From DE 10 2006 002 016 A1 a separator device is known in which a screw conveyor has surface irregularities on the outer circumference. From DE 10 2008 048 091 A1 a separator device is known, in which a clearing element comprises two rotor elements arranged parallel to one another, between the outer edges of which a clamping gap is formed. Fibrous materials can get caught in this clamping gap, causing a seal between the screw conveyor and a cylinder screen surrounding the screw conveyor and clearing the openings of the cylinder screen. Although this can result in improved clearing of the screen openings, a disadvantage of this separator device is that a high level of friction occurs between the fibrous materials picked up in the clamping gap and the inner wall of the cylinder screen arranged around the rotor elements. This can lead to undesirable high wear of the cylinder screen and further require increased drive energy to overcome the friction.

The invention is, therefore, based on the task of providing an improved solution, which addresses at least one of the problems mentioned. In particular, it is the task of the invention to provide a solution that reduces the maintenance effort as well as the frictional energy losses occurring during operation of a separator device.

### SUMMARY OF THE INVENTION

According to a first aspect, the above-mentioned problem is solved by a screw conveyor, in particular, for a separator device for dewatering moist masses, comprising a shaft extending in axial direction along an axis of rotation, at least one screw flight arranged helically around the shaft, connected to the shaft at the outer circumference of the shaft, and extending in an axial direction along at least a portion of the shaft, wherein the screw flight being an additively manufactured metallic structure and having at the outer circumference an outer edge, in which preferably at least one recess for receiving fibrous materials is arranged, preferably a plurality of recesses for receiving fibrous materials are arranged spaced from each other.

Such fibrous materials can be formed, for example, by straw or silage contained in liquid manure when the separator device is used to separate liquid manure.

A separator device is in particular to be understood as a press screw separator. The terms press screw separator and screw separator are preferably to be understood synonymously. Separator devices are used in particular for dewatering moist masses, for example, liquid manure or digestates. Separator devices are in particular adapted to separate solid and liquid components of moist masses. Thereby, liquid can be separated from the moist mass by a screening device, so that the liquid content of the moist mass is significantly reduced.

The shaft is preferably not produced by a non-additive manufacturing process. It can, for example, be produced conventionally by machining from a semi-finished product, whereby the semi-finished product can be cast, forged, or extruded. Preferably, the shaft is formed as a hollow shaft. Preferably, the shaft has a connection point, preferably comprising a groove, which is formed to connect a drive shaft to the shaft in a rotationally fixed manner. Preferably, the outer circumference of the shaft is cylindrical or substantially cylindrical. In alternative embodiments, the outer circumference of the shaft may increase in the conveying direction, for example, to achieve compression. Similarly, in alternative embodiments, it may be provided that the envelope of the screw flight(s) tapers in the conveying direction and the screen has a correspondingly congruent inner circumferential surface.

It is preferred that the shaft comprises or consists of metallic material, preferably steel, in particular, stainless steel. The axis of rotation preferably runs in the axial direction. The shaft can be rotatably supported in a separator device so that the shaft is rotatable about the axis of rotation.

The screw flight preferably extends around the shaft in a thread-like and/or helical manner, wherein the screw flight has a certain lead, wherein the lead may be constant or non-constant along the screw flight. By helical in particular thread-like and/or helical is meant. A non-constant lead can in particular be preferred if an increasing compression of a mass to be conveyed and/or an increasing axial pressure on a mass to be conveyed is to be achieved in axial direction. Preferably, the screw flight extends in axial direction along an axial partial section of the shaft or in axial direction along the entire shaft. The screw flight is preferably circumferentially, in particular, along the entire axial extension of the screw flight, material-locking connected to the shaft.

The outer edge of the screw flight is in particular to be understood as the outer circumferential surface of the screw flight. The outer edge preferably runs along the radially outer circumference of the screw flight and has a, preferably constant, width.

Preferably, several deepenings in the form of recesses are arranged in the outer edge. The individual recesses can in particular be pocket-shaped and/or groove-shaped. It is preferred that the recesses are arranged spaced apart from each other. Preferably, the recesses are formed substantially identically. Preferably, the distance between the recesses is substantially equal. Preferably, the recesses are formed to receive solids, in particular, fibrous solids. A recess may be formed as a groove or deepening. A recess can have a constant or decreasing width over its depth extent, but in preferred embodiments a recess has an undercut in such a way that the opening cross section of the recess lying in the outer edge is smaller in sections or overall than a recess cross section lying in the depth of the recess, so that fibrous materials can become trapped in the recess particularly effectively and permanently.

In particular, fibrous materials can build up in the recesses, whereby the fibrous materials remain suspended in the recesses and are moved with the screw conveyor in a rotational movement on the outer circumference of the screw conveyor in a circular orbital path. With the fibrous materials in the recesses, a kind of brush surface is preferably formed on the outer circumference of the screw conveyor, which is in contact with a screen device of the separator device and sweeps over the screen device so that the screen device is constantly cleaned by the brush surface. The fibrous materials that are present in the recesses are preferably constantly and independently renewed, so that a permanent and thorough cleaning of the screening device can be ensured.

The screw flight is an additively manufactured metallic structure. Additive manufacturing is understood to be the build-up of a component in points, layers, or portions, in which a curable material is joined to form the component by curing and bonding in a selective application process controlled on the basis of the product geometry data. The curing can take place, for example, by melting and subsequent solidification or by a crosslinking reaction. The point-, layer-, or portionwise build-up can be seen on the component by means of corresponding structures in a micrograph or on untreated surfaces.

Additive manufacturing makes it possible, on the one hand, to form an outer edge on the screw flight that is sufficiently wide to arrange recesses therein that achieve this fiber trapping effect. On the other hand, additive manufacturing makes it possible for the recesses to be produced directly in the additive manufacturing process, so that a formation with multiple recesses is possible in a time-saving manner without the need for a downstream machining operation. In this way, the geometries of the screw conveyor that are possible from the additive manufacturing process can be used advantageously for an improved functional structure of the screw conveyor. Advantageously, therefore, the improved geometry of the screw conveyor with recesses is produced by the proposed additive manufacturing process: However, also encompassed by the invention is a screw conveyor manufactured by the additive manufacturing process without such recesses; which is characterized by other geometric features; for example, the inwardly tapering cross-sectional profile of the screw flights explained below, or other advanced features explained below.

The screw conveyor according to the invention can achieve an efficient and low-cost manufacturing strategy in that the shaft can be efficiently and precisely prefabricated in a conventional process and the screw flight is additively built and manufactured in an individual and specific geometry on the shaft as a substrate element.

Also encompassed by the invention is a screw conveyor having a screw flight fabricated by a process other than an additive process and having recesses in the outer edge as described previously and hereinafter.

According to a first preferred embodiment, the screw flight has a cross-sectional profile with a width in the region of the outer circumference of the screw flight and a width in the region of the inner circumference of the screw flight, and the width in the region of the outer circumference of the screw flight is greater than the width in the region of the inner circumference of the screw flight. Here, a cross-sectional profile is to be understood as a cross section through the screw flight, for example, in a plane perpendicular to the axis of rotation of the screw conveyor or perpendicular to the flank surface of the screw flight. The cross-sectional profile is preferably designed in such a way that in the region of the inner circumference of the screw flight, the width of the screw flight is less than in the region of the outer circumference of the screw flight. In particular, the cross section is designed in such a way that the screw flight becomes wider, preferably steadily wider, from radially inward to radially outward in the radial direction. This means in particular that the screw flight is wider in the region of the outer circumference of the screw flight than in the region of the inner circumference and accordingly the screw flight has a smaller width in the region of the inner circumference of the screw flight than in the region of the outer circumference.

The screw flight preferably has a cross-sectional profile that widens in the radial direction towards the outside, preferably continuously.

It is particularly preferred if the cross-sectional profile of the screw flight has at least one section with a constant width and at least one section with a varying, in particular, radially outwardly increasing, width. These sections can in particular in the radial direction be adjacent to each other.

According to a preferred embodiment, the cross section is formed in such a way that the screw flight has an inner section with constant width from radially inward to radially outward in the radial direction and/or has a middle section with outwardly increasing width and/or has an outer section with constant width.

The screw flight is preferably designed in such a way that less material is applied near the axis of rotation of the screw flight, or at smaller radii, than at larger radii. In the area close to the axis of rotation, a layer build-up can therefore be carried out in an advantageous manner quickly and thus at low cost. In the area far from the axis of rotation or at larger radii, a wider structure can be applied. Preferably, fibrous material pockets are arranged in the wide outer structure.

Such a screw conveyor can be used in a separator device in an advantageous way, whereby a low-maintenance, service-friendly dewatering is made possible, for example, in a liquid manure- or digestate treatment.

However, a screw conveyor described herein can also be used in a screw conveyor or another device that is not used for dewatering moist masses.

An advantage of such a screw conveyor is that, due to the plurality of spaced recesses, there is no continuous recess and thus friction losses due to friction between solids present in the recesses and a screening device, that is arranged around the screw conveyor in a separator device, are reduced. As a result, the wear of such a screening device can be reduced. Consequently, the service life of the components used can also be increased and the maintenance frequency reduced. In addition, due to reduced friction losses, less drive energy is required to drive the screw conveyor, which can reduce the overall energy requirement of the separator device.

Another advantage of such a screw conveyor is that a considerable material saving can be achieved by means of the cross section of the screw flight, which becomes wider radially outwards. As a result, less material is required for the screw flight, which can reduce the material costs for the screw conveyor. In addition, the screw conveyor can thus have a reduced weight compared to conventional screw conveyors due to the lower material usage, which in particular can facilitate maintenance operations.

Typically, during operation of the screw conveyor, the outer circumference of the screw flights is subjected to high mechanical stress and the outer edge of the screw conveyor is typically the area of the screw conveyor most affected by wear. Due to the design of the screw flight, in which the screw flight is wider in the area of the outer circumference than in the area of the inner circumference of the screw flight, the wear can be compensated by the high material application in the outer area and the resulting wide outer edge. On the one hand, an axially longer but radially larger gap can be formed to the inner wall of the screw or screen tube, resulting in a lower surface load between the outer edge of the screw flight and the screen, and reducing wear on both sides. Thus, the screw conveyor and the screw or screen tube have an advantageous increased service life.

According to a particularly preferred embodiment, the screw flight is a structure produced by wire-based additive manufacturing by means of arc welding, in particular, by means of gas metal arc welding (GMAW), preferably by means of metal inert gas welding (MIG) and/or metal active gas welding (MAG).

The screw flight then has, in particular, the structure typical of wire-based additive manufacturing by means of arc welding. Preferably, the screw flight is obtained by means of wire arc additive manufacturing. Particularly preferably, the “Wire Arc Additive Manufacturing (WAAM)” process is used, by which is meant in particular a type of 3D printing for metal structures by means of welding process. It is preferred that arc welding is used to build up the component in layers, whereby a metal wire is fused at the right place with the aid of a welding torch that the desired raw part is thus formed. Minimally, a three-axis movement is required for the production of complex structures in order to rotate the component on the one hand and to move the welding head in the axial and radial direction on the other hand. By a rotatable build platform in conjunction with swivel axes of the build platform or the welding head the material build up can be carried out 5-axial to 8-axial, for example. In this way, complex structures with cavities, in particular, in the form of recesses, can be produced. A finished component built up in this way can then, for example, if certain requirements are placed on the surfaces, be reworked by mechanical finishing, such as for example CNC milling.

Arc welding refers in particular to a welding process in which an electric arc (welding arc) burns between the workpiece and an electrode, which can melt away and then simultaneously serves as a filler metal.

Gas-shielded arc welding refers in particular to a welding process in which shielding gases are used which flow around the electrode and the molten metal. The supply of shielding gases can be integrated in the torch. In gas metal arc welding (GMAW), an electrode can be melted off that is made of the same or similar material as the workpiece. Metal inert gas welding (MIG) is to be understood in particular as a form of gas metal arc welding, in which inert gases are used that do not undergo any chemical reactions with the melt. Metal active gas welding (MAG) is to be understood in particular as a form of gas metal arc welding in which reactive gases are used to deliberately change the composition of the melt. The addition of such an active gas enables, for example, a locally selective change in the properties of the screw flight, e.g., the area of the outer edge or the area of the conveying flank of the screw flight can be made with a greater material hardness than areas of the screw flight located radially further inwards, which have tougher material properties.

One advantage of such an additively manufactured screw flight is that more material can be applied to anticipated wear at certain points, for example, in the area of the conveying flank, in particular at the conveying flank, especially at the last flank in the conveying direction, of the screw flight, and/or a harder and/or more wear-resistant, in particular, higher-quality, material can be used compared to the material used in the rest. Applying metallic paths comprising or consisting of different materials offers the advantage that different materials can be used for different areas of the screw flight, wherein the materials are adapted to the requirements defined for these areas in each case.

According to a preferred embodiment, the screw flight is built up in layers, obtained by: applying of several metallic paths by means of melting off a metal wire, wherein the paths are arranged parallel to each other and run along the thread running direction of the screw flight.

Preferably, metal paths are applied to the shaft by means of buildup welding. The buildup welding can thereby take place automated. Several metal paths can be applied in parallel next to each other. Advantageously, the metal paths run in thread running direction of the screw flight.

It is preferred, that the screw flight is built up in layers, obtained by: applying a metallic path by means of melting off a metal wire, wherein the path preferably runs along the thread running direction of the screw flight, and preferably applying at least one further path, which is arranged parallel to the applied path and is arranged in a layer with the previously applied path, determining the height of the applied path in the radial direction, applying a metallic path by means of melting off a metal wire in a layer lying radially above the already applied path, wherein the positions at which the metal wire is melted off for the application of this path is carried out as a function of the previously determined height of the applied path, and preferably applying a plurality of layers arranged one above the other in the radial direction, each having at least one path, until a desired height is reached and/or exceeded, wherein preferably the height of at least one path of the previously applied layer is determined in the radial direction before the application of each new layer.

It is also preferred that the screw conveyor has several, preferably two, screw flights that are arranged offset from each other in circumferential direction, in particular 180° offset from each other, and thus form a screw channel between them. In this case, a screw flight then forms two screw channels between two of its auger flights. A screw with one helically rotating screw flight thus forms a single-start screw, a screw with two screw flights forms a two-start screw and, in general, a screw with n screw flights forms an n-start screw. Wherein it should be understood that the lead of the screw corresponds to n times the pitch of the screw.

The screw flights and the screw channels are preferably formed in the same shape, wherein preferably each of the screw flights has a plurality of recesses in the circumferential outer edge of the screw flight, which are circumferentially spaced from each other along the circumferential outer edge of the screw flight. The recesses of one screw flight are also preferably in axial direction offset from the recesses of another screw flight.

The screw conveyor is preferably designed multi-start, preferably double-start. In particular, it is preferred that the screw conveyor is of multi-start design and thus has several screw flights. Preferably, the conveying screw is of double-start design, so that the screw conveyor has a plurality of, preferably two, screw flights, which preferably have the same shape and are arranged offset from one another by 180° in the circumferential direction. A two-start design means in particular that the screw conveyor has two screw flights.

In the case of a two-start screw conveyor, a new screw flight starts at 180°, and in the case of a three-start screw conveyor accordingly at every 120°. The starts of the screw flights are therefore offset by 180° and 120° respectively.

It is further preferred that in the screw flight in the circumferential direction within an angular range of 360° at least one recess is arranged, preferably at least two recesses are arranged, particularly preferably at least three recesses are arranged.

One full rotation around the axis of rotation corresponds to 360°.

The number of recesses is preferably at least or exactly two, particularly preferably at least or exactly three, for each screw flight present per full rotation. The total number of recesses on a screw flight can be determined by multiplying the number of recesses per full rotation by the number of rotations of the screw flight.

It is particularly preferred if the recesses each have a longitudinal extension along a recess longitudinal axis, the recess longitudinal axis being oriented obliquely, in particular, at an angle of at least 2.5° or at least 5°, preferably at least 10°, to the thread running direction of the screw flight. Thereby, the recess longitudinal axis is preferably oriented obliquely to the thread running direction of the screw flight in such a way that compared to the thread running direction of the screw flight the recess longitudinal axis is oriented further, in particular with an angle of at least 5°, preferably at least 10°, relative to the thread running direction, in direction of the axial direction.

By such an embodiment it is in particular to be understood, that the longitudinal extension of the recesses is oriented further in direction of the axial direction compared to the thread running direction of the screw flight.

With such an oblique arrangement of the recesses, it can be achieved in an advantageous manner that, compared to an arrangement of the recesses in the direction of the t thread running direction, fewer recesses and/or shorter recesses are sufficient to sweep over a cylinder spanned by the recesses with the recesses completely and without interruptions during rotation of the screw flight about the axis of rotation.

Furthermore, an advantage of such an oblique arrangement of the recesses is that the cleaning effect of a screening device of a separator is improved due to this oblique arrangement compared to a non-oblique arrangement.

Still further, it is preferred that the recesses each have a length in the thread running direction of the screw flight and a width in the width direction of the screw flight and the length is at least twice the width, wherein preferably the length of the recesses is at least half as long, preferably at least as long, as the distance between the recesses.

The length of the recesses and the spacing between the recesses are preferably selected so that, during one full rotation of the screw conveyor about the axis of rotation, each point of a surface of rotation spanned by the outer circumference of the screw flight is swept by at least one of the recesses.

One advantage of recesses designed and arranged in this way is that, when the screw conveyor is used in a separator device, the inner wall of the screening device, which constitutes the surface of rotation, can be completely swept by the solids accommodated in the recesses. In this way, a permanent cleaning of the screening device by means of the solids can be achieved and a clogging of liquid passages in the screening device can be avoided.

The recesses are preferably evenly spaced from one another in the circumferential direction on the screw flight. Preferably, the distance between the adjacent recesses is the same.

Preferably, the recesses each have an opening in the outer edge of the screw flight, the opening having a contour with a plurality of, preferably at least two, acute angles, preferably with an angle less than 90°, particularly preferably with an angle less than 60°.

The recesses preferably have openings on the outer circumferential surface of the screw flight and form pocket-shaped material recesses in the screw flight. The openings preferably have several, in particular, acute-angled edges. With such acute-angled edges, solids can be particularly preferably picked up by the recesses and held in the recesses during the rotational movement, in particular, by means of clamping of fibrous solids.

It is further preferred that the cross-sectional profile of the screw flight has at least one, preferably two, negative flank angles.

A flank angle is in particular understood as the angle between a side surface, which can be referred to in particular as a flank, and a plane lying perpendicular to the axis of rotation. The flank angle can be negative both on the conveying side and on the opposite side of the screw flight. In the case of a negative flank angle, the cross section of the screw flight becomes wider in the radial direction towards the outside. In contrast to such a negative flank angle, bolt threads generally have positive flank angles (often between 30° and 60°). It is particularly preferred if the negative flank angle has an angular amount of at least 5°, preferably at least 10°, especially preferably at least 15°. Such flank angles can still be executed with a nozzle longitudinal axis of the welding head that is perpendicular to the axis of rotation or the circumferential surface of the shaft if the welding parameters are selected correctly. By swiveling the nozzle longitudinal axis, larger flank angles also become possible.

It is particularly preferred if the flank angle is not constant, in particular, is negative in one section and is 0° in at least one section, preferably in two sections. A flank angle of 0° is to be understood in particular as a flank running exactly in radial direction, i.e., that lies in a plane perpendicular to the axis of rotation.

Preferably, the screw flight has an inner diameter and an outer diameter and the screw flight is wider in the area of the outer diameter than in the area of the inner diameter. Preferably, the screw flight is at least a factor of 1.5 wider in the region of the outer diameter, and particularly preferably at least twice as wide, as in the region of the inner diameter.

Such a structure, which widens towards the outside, can be produced particularly advantageously by means of an additive manufacturing process. The production of such a structure, on the other hand, would be complex in terms of manufacturing technology and a much higher material consumption would be necessary in a machining process and a complex mold would be required in a casting process due to the undercuts.

It is further preferred that the screw conveyor has an envelope that tapers, preferably conically tapers, from a first end of the screw conveyor to a second end of the screw conveyor. Such a screw conveyor can be manufactured particularly advantageously in an additive process. The tapering outer contour benefits from the sealing by recesses, which allows the outer edge to be manufactured with greater tolerances. Due to the tapered outer contour, the screw conveyor can be inserted in a correspondingly tapered screen tube and then allows an axial adjustment for the purpose of wear compensation.

According to a further aspect, the above-mentioned problem is solved by a screw conveyor, in particular, for a separator device for dewatering moist masses, comprising a shaft extending in axial direction along an axis of rotation, a screw flight arranged to extend helically around the shaft, connected to the shaft at the outer circumference of the shaft, and extending in axial direction along at least a portion of the shaft, wherein the screw flight is an additively manufactured metallic structure, preferably obtained by wire-based additive manufacturing by means of arc welding, in particular, by means of gas metal arc welding (GMAW), preferably by means of metal inert gas welding (MIG), and/or metal active gas welding (MAG), and/or wherein the screw flight is built up in layers, obtained by: applying several metallic paths by means of melting off a metal wire, wherein the paths are arranged parallel to each other and run along the thread running direction of the screw flight.

Particularly preferred embodiments of such a screw conveyor are set forth in connection with the other aspects described herein, particularly with the first aspect. These preferred features and preferred embodiments also constitute preferred features and preferred embodiments in connection with this aspect.

According to a further aspect, the above-mentioned task is solved by a separator device for dewatering moist masses, in particular, liquid manure and/or digestates, comprising a drive shaft rotatably mounted about a drive axis of rotation, a screw conveyor, wherein the screw conveyor is connected to the drive shaft for torque transmission from the drive shaft to the screw conveyor, a screening device which encloses at least a part of the screw conveyor, wherein the screening device has a liquid-permeable screen wall for dewatering the moist mass.

The drive shaft preferably extends along the axis of rotation and is rotatably mounted about the axis of rotation. The drive shaft is preferably coupled to the shaft in a rotationally fixed manner so that the drive shaft can transmit a torque to the shaft. The shaft can thus be driven by the drive shaft by means of torque transmission, so that the shaft rotates about the axis of rotation. The screening device has a liquid-permeable screen wall, which is formed in such a way that liquids can pass through the liquid-permeable screen wall. Solids, in particular, solids with a certain minimum particle size, on the other hand, cannot pass through the liquid-permeable screen wall. Thus, moist masses can be dewatered in that a liquid portion of the moist masses passes through the screening device and the dewatered moist masses, which normally have a certain residual moisture, are led out of the separator device in an axial direction by the screw conveyor.

The separator device can preferably be equipped with a screw conveyor having in axial direction tapering envelope, wherein then preferably the screen device extends from a first end to a second end and has an inner wall which is rotationally symmetrical about the drive axis of rotation, whose inner diameter also tapers, preferably conically tapers, from the first end to the second end, wherein preferably the screw conveyor is axially adjustable relative to the screen device by means of an axial adjustment device. This enables the screw conveyor to be readjusted to compensate for wear.

According to a further aspect, the aforementioned task is solved by a method for additively manufacturing a screw conveyor, in particular, a screw conveyor as described herein, comprising the steps: providing a shaft extending in axial direction along an axis of rotation, additive manufacturing of a screw flight on the shaft by layer-by-layer material deposition, comprising: depositing a metallic path by means of melting on a metal material, preferably a metal wire, wherein the path preferably extends along a thread running direction of the screw flight, and preferably applying further paths that are arranged parallel to the deposited paths.

Additive manufacturing is in particular understood to mean a manufacturing using a manufacturing process in which material is applied layer-by-layer and thus a three-dimensional object is created.

The shaft can be an additively manufactured shaft or a non-additively manufactured shaft. The screw conveyor is also referred to here as additively manufactured if only a part of the screw conveyor, in particular, the screw flight, is additively manufactured and, for example, the shaft is a non-additively manufactured component. The shaft is preferably a non-additively manufactured component.

The shaft preferably has a connection point for connection to a drive shaft so that in particular from a drive shaft a torque can be transmitted to the shaft and the shaft can thus be set in rotational motion about the axis of rotation.

The screw flight is preferably manufactured additively and thus built up in layers. The metallic layers are preferably applied by melting off a metal wire with a welding machine and then solidifying the molten metal at a predetermined position. In this way, a continuous metallic path can be applied. It is preferred if several paths, for example, two paths, are applied thread-like onto the surface of the shaft running in parallel, side-by-side. These parallel running paths form a first layer. Preferably, a second layer is applied onto this first layer in the same way, wherein the second layer also comprises several parallel running paths. Then, preferably a third layer, and preferably further layers, each comprising a plurality of parallel running paths, are applied. It is particularly preferred if the paths in the different layers are all arranged to run parallel to one another.

It is particularly preferred if the number of paths per layer increases radially outward at least between two of the layers, preferably between several of the layers. In this way, a widening of the cross-sectional structure of the screw flight in the radially outward direction can be achieved.

A particular advantage of such a process for manufacturing a screw conveyor is that no cooling is required during the additive application of the paths, because the paths are applied one after the other in a thread-like manner and there is thus sufficient time for the applied material to solidify and cool before material is applied again in the same area.

It is preferred if several screw flights, in particular, two screw flights arranged offset to each other, are built up on the shaft according to this method. Preferably, the screw flights are of uniform design.

According to a particularly preferred embodiment, the screw flight is built up in layers in such a way that the screw flight has a plurality of spaced-apart recesses on the outer circumference of the screw flight for receiving, in particular, fiber-containing, solids.

Preferably, the recesses are formed in the screw flight by interrupting the material application in the area of the recesses during the layer-by-layer application of metallic paths. In this way, the recesses can be introduced directly into the screw flight during the layer-by-layer application of the metallic paths, without the need for a separate production step and/or subsequent removal of previously applied material to introduce recesses. By interrupting some of the metallic paths, the shape of the recesses can be improved and/or carried out according to individual requirements. This means that it is not absolutely necessary to remove material in order to make the recesses. Thereby also in an advantageous way the manufacturing of the screw conveyor can be simplified and the number of manufacturing steps for manufacturing the screw conveyor can be reduced.

It is particularly preferred that the screw flight is built up in layers such that the screw flight has a cross-sectional profile having a width in the region of the outer circumference of the screw flight and a width in the region of the inner circumference of the screw flight, and the width in the region of the outer circumference of the screw flight is greater than the width in the region of the inner circumference of the screw flight.

Preferably, fewer metal paths arranged parallel to one another are applied in one layer, in particular, in the first layer, in the region of the inner circumference of the screw flight than in one of the radially more outer layers, in particular, in the radially outermost layer, in the region of the outer circumference of the screw flight.

It is particularly preferred that the method comprises the following steps: determining the height of an already applied path in radial direction, applying a metallic path by means of melting on a metal material such as a metal wire in a layer lying radially above the already applied path, wherein the positions at which the metal material for applying this path is melted on is set as a function of the previously determined height of the already applied path, and preferably applying a plurality of layers arranged one above the other in the radial direction, each with at least one path, until a desired height is reached and/or exceeded, wherein preferably before the application of each new layer the height of at least one path of the previously applied layer in the radial direction is determined.

When applying the metallic paths, the flow and solidification behavior of the applied material can be dependent on ambient conditions, in particular, on the ambient temperature and/or the temperature of the shaft. Thus, in particular, the shape of the applied paths can be dependent on the ambient conditions. In particular the height in radial direction of the applied paths can be influenced by the ambient conditions, so that in particular under different ambient conditions the applied paths can have different heights.

An advantage resulting from such a determination of the height of an already applied path in radial direction is that a path in a layer arranged above an applied path can be applied in a positioned manner in dependence of the determined height of the applied path. Thereby, the application of superimposed paths can be carried out in such a way that the paths are applied in the radial direction at the desired height above the already applied paths. A positioning of the metal wire too high or too low during melting off the metal wire can be avoided in an advantageous manner. The metal wire can then even under different ambient conditions be melted off in the correct positioning, in particular, in the radial direction at the correct height.

The number of layers can be predetermined. However, it is preferred that a nominal height in the radial direction is specified and the number of layers is determined as soon as the nominal height is reached and/or exceeded with one layer. In this way, it can be achieved in an advantageous manner that the specified height of the screw flights is achieved regardless of the height of the applied paths, which depends on the ambient conditions.

It is further preferred that the determination of the height of the applied path in radial direction is done by means of the following steps: placing a surface of a welding head or a metal wire protruding from a welding head, which has a known length, on a reference plane, applying a metallic path by means of melting off the metal wire, if necessary placing the metal wire protruding from the welding head again on the reference plane to determine the length of the metal wire, placing the surface of the welding head or the metal wire on the surface of the applied path and detecting the placement of the surface of the welding head or the metal wire on the surface, in particular, by detecting a contact force or detecting an electrical connection between the surface of the welding head or the metal wire and the deposited path, determining the position of the surface of the deposited path in dependence of the position of the welding head when the surface of the welding head or the metal wire is placed on the deposited path and, if necessary, of the length of the metal wire.

In principle, by placing a surface of the welding head on a surface of a welded path, the geometric position of the surface of the welded path can be determined in an always repeatable manner, and consequently the height of the welded path in radial direction can be determined. By means of placing a metal wire protruding from a welding head, which has a known length, on the reference plane, the position of the metal wire protruding from the welding head can be determined by detecting a current flow during placement, so that in particular the position of the welding head in which the metal wire is held is known for production. With the position of the wire known, a path with predetermined position data can then be applied. After the metallic path has been applied, the metal wire can then again be placed on the reference plane, wherein for example if a current flow is detected, the contact of the metal wire to the reference plane can be detected and thus the length of the metal wire—which may now have changed after the welding process has been carried out—can be determined on the basis of a position determination of the welding head. It is particularly preferred if the height of the applied metallic path is subsequently determined by placing the metal wire on the surface of the applied path and the placement of the metal wire on the surface, in particular, by detecting a contact force or detecting an electrical connection between the metal wire and the applied path, is being detected. In particular, when the metal wire is placed on the applied path, the height of the applied path in the radial direction can be determined based on the known length of the metal wire and the known position of the welding head.

These method steps for determining the height of an applied metallic path can be carried out after the application of each path and/or each layer and/or at a different frequency. Depending on the determined height, the positioning of the path to be subsequently applied can then be adjusted in each case.

Still further it is preferred that the manufacturing of the screw conveyor takes place by wire-based additive manufacturing by means of arc welding, in particular, by means of gas metal arc welding (GMAW), preferably by means of metal inert gas welding (MIG) and/or metal active gas welding (MAG), by means of at least one welding robot.

It is preferred that the additive manufacturing of the screw flight takes place automated by means of the welding robot using digital production data.

Still further, it is preferred that the method comprises: chip removal of additively applied material at the outer circumference of the screw flight for reduction of the roughness of the screw flight at the outer circumference of the screw flight and/or for production of a straight outer edge at the outer circumference of the screw flight, and preferably chip removal of additively applied material at the flanks of the screw flight for reduction of the roughness of the screw flight at the flanks of the screw flight.

Preferably, mechanical finishing of the additively manufactured screw flight is carried out after the application of the metallic paths. By means of mechanical finishing in particular the surface waviness and/or the surface roughness can be reduced. In particular, by means of such a mechanical finishing a circumferential and straight edge parallel to the axial direction on the outer circumference of the screw flight can be produced.

Flanks of the screw flight are in particular to be understood to mean the lateral outer surfaces of the screw flight.

It is further preferred that the shaft is clamped in a holder and is movable by means of movement of the holder, in particular, rotatable about the axis of rotation, and/or the at least one welding robot has at least six electromechanically driven axes.

It is particularly preferred that the layered buildup of the screw flight is carried out by means of application of paths arranged in parallel, wherein the paths run along the thread running direction of the screw flight, wherein preferably a part of the paths is formed continuously along the entire screw flight in each case and/or a part of the paths has interruptions in each case in the region of the recesses and is not formed continuously along the entire screw flight and/or a recess is formed by the course of the paths.

By means of such a layered buildup of the screw flight, in a particularly advantageous manner recesses can be introduced into the structure by interruptions of the applied paths. As a result, in particular, compared to conventional production of similar recesses fewer production steps are required and less material is needed for the production. The individual paths can run, for example, in such a way that they run in a first region of the outer circumference as a number of N parallel paths, but in contrast run in a second region of the outer circumference as a number of N minus M parallel paths, wherein M is an integer of at least 1. This difference in the number of parallel lying paths can be achieved by corresponding ending and starting of paths and leads to the formation of recesses in the outer circumference of the screw flight. First and second sections can thereby always be arranged alternately along the circumference. Preferably, in particular, in the first section two of the paths can thereby run parallel, one of which has been started in the application direction before the first section and/or one of which has been ended in the application direction after the first section. Further preferably, a path can extend over the first and the second section and, in a transition section between the first and the second section, have a course oriented obliquely to the parallel direction. This enables an exact boundary of a recess. Furthermore, an advantageous cutout contour with one or two acute angles is achieved, resulting in an advantageous entanglement of fibers in the recess.

Further it is preferred that the number of parallel paths in the area of the inner diameter of the screw flight is less than the number of parallel paths in the area of the outer diameter of the screw flight.

It is preferred that the number of paths per layer is increased outward in radial direction. In this way, a structure of the screw flight that becomes wider towards the outside can be achieved for paths with essentially the same cross section.

It is further preferred that the method comprises the following steps: creating production data for the positioning of the melting off of the metal wire when applying the path, comprising the steps: creating a digital basic structure mapping cross-sectional information, in particular, comprising a nominal height and a width dependent on the height, of a screw flight, replicating the digital basic structure in a predetermined threading motion that corresponds to the thread shape of the screw flight.

It is preferred that the basic digital structure includes information about the cross section of the screw flight. The number of paths per layer can then be determined as a function of the height of the respective layer and the width of the cross section to be produced at this height, preferably during the production process, in particular, several times, for example, for each layer before the manufacturing of each layer. In particular, the number of layers may result as a function of the total height of the given cross section. A comparison between the nominal and actual height can preferably be made after individual layers have been manufactured, in particular, after the manufacturing of each of the layers.

It is particularly preferred that the geometry of the screw conveyor is programmed in mathematical functions in a robot controller. Preferably, thereby several coordinate transformations are performed so that each point on the surface of the individual screw flights can be addressed via the longitudinal and transverse directions of the flights. Pivot-, rotation-, and axis positions for a welding robot intended for additive manufacturing can be calculated directly by the coordinate transformations. Preferably, a path planning for the metallic paths to be applied is performed exclusively in the longitudinal direction of the screw flights and the transverse direction of the screw flights.

It is particularly preferred if the processing starts at a certain minimum radius. Preferably, at a certain boundary radius, the screw flight widens in the transverse direction of the screw flight, wherein the area between the limiting flanks is automatically filled if one or more metallic paths can be applied. Preferably, from a further certain boundary radius, the width remains constant in the transverse direction, wherein the area between the limiting flanks is automatically filled if one or more metallic paths can be applied. Preferably, above a certain radius, the screw flights are no longer completely filled, but are provided with recesses. For this purpose, preferably an algorithm is defined that performs the outlining of recesses and filling of their interspaces for certain heights and positions on the screw flight. Preferably, the processing is completed as soon as a certain radius is reached.

It is particularly preferred to apply the layers completely one after the other, in particular, to first apply one layer completely and then to apply the next layer completely, in order to keep a heat input as uniform as possible.

According to a further aspect, the aforementioned task is solved by a use of a screw conveyor as described herein, in a separator device, preferably a separator device as described herein, for dewatering moist masses, in particular, for dewatering digestate and/or liquid manure.

The aspects described above and their respective possible advanced formations have features or method steps that make them particularly suitable for being produced using a process described herein and its further formations.

For the advantages, embodiments, and details of embodiments of the various aspects of the solutions described herein and their respective possible further formations, reference is also made to the description regarding the corresponding features, details, and advantages of the respective other aspects and their further formations.

### BRIEF DESCRIPTION OF THE DRAWINGS

Preferred embodiments are explained by way of example with reference to the accompanying figures. It shows:

FIG. 1 is a schematic perspective representation of a section of a screw conveyor with two screw flights arranged 180° offset from each other, wherein only a section of half a rotation of the two screw flights is shown;

FIG. 2 is a schematic side view of the section shown in FIG. 1 of a screw conveyor with two screw flights arranged 180° offset from each other;

FIG. 3 is a schematic side view of the section shown in FIG. 1 of a screw conveyor with two screw flights arranged 180° offset from each other;

FIG. 4 is a schematic view in direction of the axis of rotation of the section shown in FIG. 1 of a screw conveyor with two screw flights arranged 180° offset from each other;

FIG. 5a is a schematic view of a first intermediate state of a screw conveyor during the manufacturing of the screw conveyor;

FIG. 5b is a schematic view of a second intermediate state of a screw conveyor during the manufacturing of the screw conveyor;

FIG. 5c is a schematic view of a third intermediate state of a screw conveyor during the manufacturing of the screw conveyor;

FIG. 6 is a schematic representation of a separator device with a screw conveyor; and

FIG. 7 is an exemplary schematic sequence of a method for additive manufacturing of a screw conveyor.

In the figures, identical or essentially functionally identical or similar elements are designated with the same reference signs. Dashed lines shown in gray in the figures indicate in particular contours that are covered by a component.

### DETAILED DESCRIPTION OF THE EMBODIMENTS

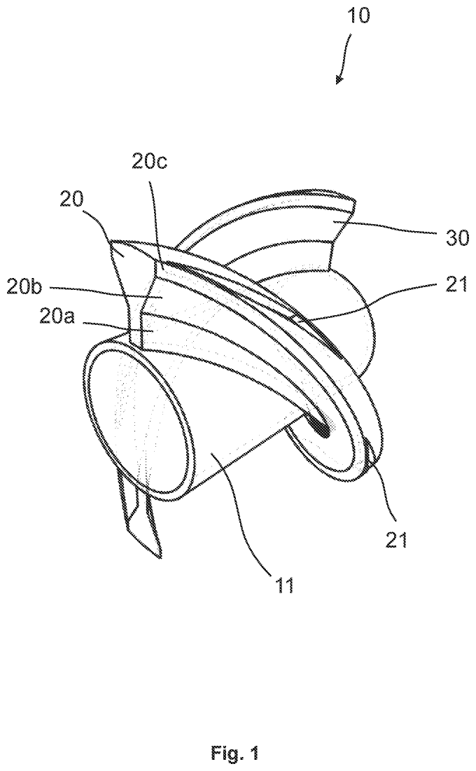

FIG. 1 shows a schematic perspective representation of a section of a screw conveyor 10 with two screw flights 20, 30 arranged 180° offset from each other, wherein only a section of half a rotation of the two screw flights 20, 30 is shown. A screw conveyor 10 described herein can in particular be formed to be considerably longer than in the figures shown herein (in which it is shown only in section), in which case each screw flight 20, 30 has several rotations about the shaft 11. The screw flights 20, 30 are arranged in a thread-like manner on the shaft 11 and were applied to the shaft 11 in layers by means of additive manufacturing. The width of screw flights 20, 30 in the region of the inner circumference of the screw flights 20, 30 is smaller than the width of the screw flights 20, 30 in the region of the outer circumference of the screw flights 20, 30, respectively. In the region of the outer circumference, the screw flight 20 has a plurality of recesses 21 spaced apart from each other. The screw flight 30 also has a plurality of recesses spaced apart from each other. The screw flights have a cross-sectional profile with a width in the region of the outer circumference 20c of the screw flight 20 and a width in the region of the inner circumference 20a of the screw flight 20. The width 20c in the region of the outer circumference of the screw flight is thereby larger than the width 20a in the region of the inner circumference of the screw flight. Between the inner and outer regions, a central region 20b is arranged in which the cross section is formed to become wider towards radially outwards.

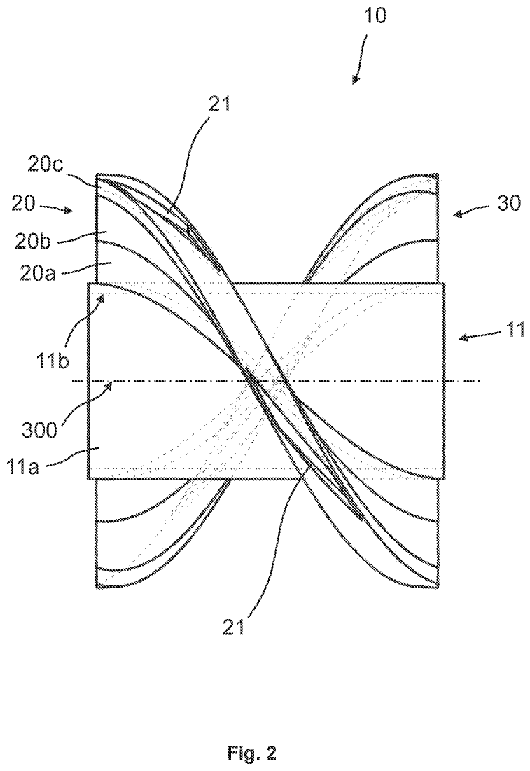

FIG. 2 shows a schematic side view of the section shown in FIG. 1 of a screw conveyor with two screw flights 20, 30 arranged 180° offset from each other that are mounted on a shaft 11. The shaft 11 can be rotatably mounted about an axially extending axis of rotation 300. The shaft 11 is cylindrical formed as a hollow shaft. The shaft 11 has an outer circumference 11a and an inner circumference 11b (shown by a gray dashed line).

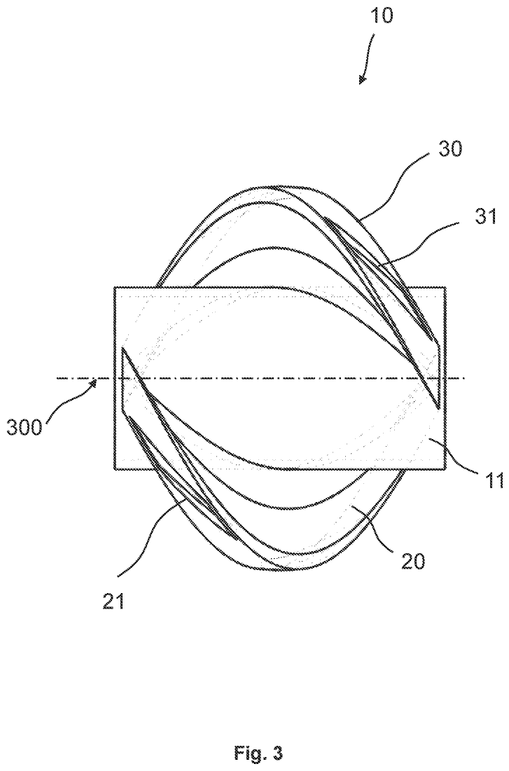

FIG. 3 shows a schematic side view of the section shown in FIGS. 1-2 of a screw conveyor with two screw flights 20, 30 arranged 180° offset from each other. The section shown is the section shown in FIG. 2, but wherein the screw conveyor is rotated 90° about the axis of rotation 300 compared to the representation in FIG. 2.

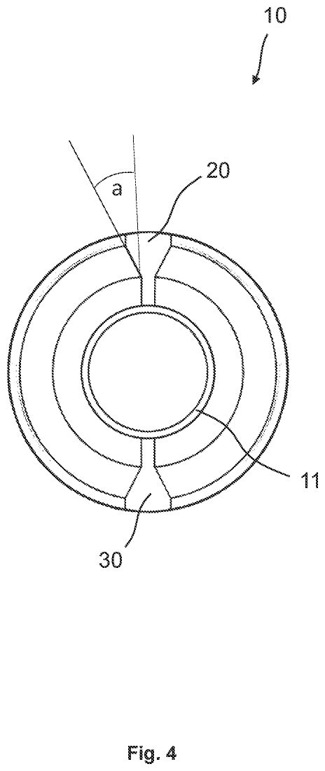

FIG. 4 shows a schematic view in direction of the axis of rotation of the section of a screw conveyor shown in FIGS. 1-3 with two screw flights arranged 180° offset from each other. Thereby, the cross section which widens radially outward or the cross-sectional profile which widens radially outward of the screw flights 20, 30 can be seen.

At the screw flight 20, the negative flank angle a is drawn in a region. The region in which the flank angle a is negative is arranged between a radially inner and a radially outer region, wherein in the radially inner and the radially outer region the flank angle is not negative but is 0°.

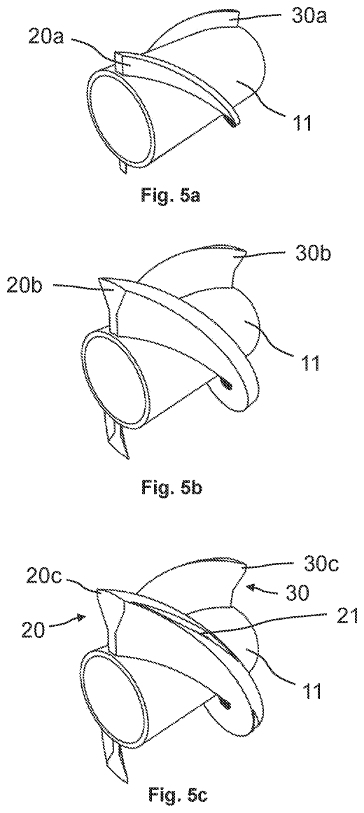

FIG. 5a shows a schematic view of a first intermediate state of a screw conveyor during the manufacturing of the screw conveyor. First layers 20a, 30a, each consisting of a plurality of metallic paths arranged in parallel, have been applied to the shaft. The layers have thereby been applied on top of each other radially outwards.

FIG. 5b shows a schematic view of a second intermediate state of a screw conveyor during the manufacturing of the screw conveyor. After the state shown in FIG. 5a, further layers 20b, 30b, which become wider radially outward, were applied in layers.

FIG. 5c shows a schematic view of a third intermediate state of a screw conveyor during the manufacturing of the screw conveyor. After the state shown in FIG. 5b, further layers 20c, 30c positioned in the area of the outer circumference of the screw flights 20, 30 were applied in layers. Thereby, the metallic paths were interrupted in the area of the recesses 21 when the metallic tracks were applied, so that the recesses were created during the additive manufacturing of the screw flights without the need to subsequently introduce the recesses by milling or other mechanical processing.

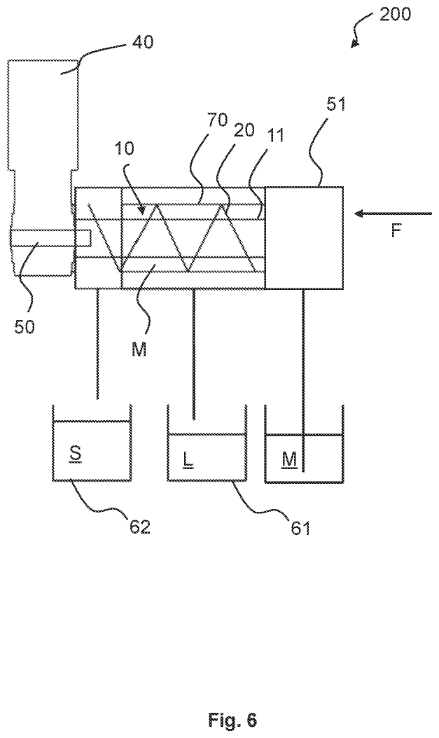

FIG. 6 shows a schematic sectional view of a preferred embodiment of a separator device 200. The separator device 200 is configured to dewater a moist mass M in order to provide a dewatered mass S with a desired dry mass content. For this purpose, the separator device 200 has a drive shaft 50 which is rotatably mounted about an axis of rotation and extends in an axial direction. The drive shaft 50 is driven by a motor shaft of a drive unit 40.

For conveying the moist mass M to be dewatered in a conveying direction F and for separating the liquid L from the mass M to be dewatered to provide a dewatered mass S having a desired dry mass content, a screw conveyor 10 is rotatably arranged within a screening device 70 so that the screening device 70 surrounds the screw conveyor 10.

The screw conveyor 10 and the screening device 70 are designed in such a way that the screw conveyor 10 lies tightly against the screening device 70, in particular, against an inner screen surface of a fluid-permeable screen wall of the screening device 70. Due to this arrangement, the moist mass M to be dewatered is compressed via an inlet chamber 51 in the conveying direction F between the screw conveyor 10 and the screening device 70 in dependence of an existing conveying pressure. This causes the liquid L from the moist mass M to be pressed through the fluid-permeable screen wall of the screening device. The fluid-permeable screen wall has outlet openings, which extend between the inner screen surface of the screen wall, which faces the screw conveyor 10, and an outer screen surface of the screen wall, which is radially outer with respect to the inner screen surface and faces away from the screw conveyor 10. Through the outlet openings, the liquid L separated from the moist mass M can emerge from the screening device 70 and be collected in a container 61. The dewatered mass S exits the separator device and can for example be collected in a container 62.

The size of the outlet openings is designed in such a way that the liquid L, but not the solids of the moist mass M, can exit the screening device 70 through the screen wall, so that the solids of the moist mass M are guided through the screening device 70 to an outlet.

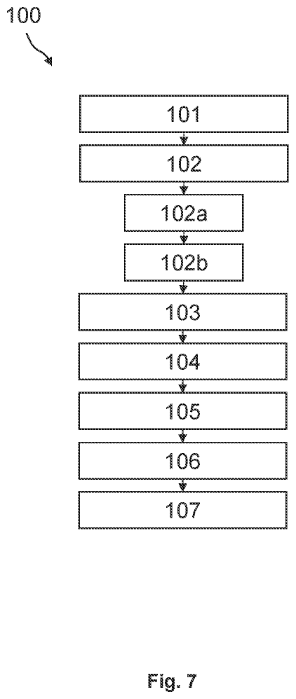

FIG. 7 an exemplary schematic sequence of a method 100 for additive manufacturing of a screw conveyor, wherein the manufacturing of the screw conveyor takes place by wire-based additive manufacturing using gas metal arc welding (GMAW) using a welding robot, comprising the steps:

In step 101, providing a shaft extending in axial direction along an axis of rotation. In step 102, additive manufacturing of a screw flight on the shaft by layer-by-layer material deposition, comprising the steps 102a, applying a metallic path by means of melting off a metal wire, wherein the path preferably extends along the thread running direction of the screw flight, and 102b, applying further paths that are arranged parallel to the applied paths. Thereby, the screw flight is built up in layers in such a way that the screw flight has a cross-sectional profile having a width in the region of the outer circumference of the screw flight and a width in the region of the inner circumference of the screw flight, and the width in the region of the outer circumference of the screw flight is larger than the width in the region of the inner circumference of the screw flight. In addition, the screw flight is built up in layers in such a way that the screw flight has a plurality of recesses spaced apart from each other at the outer circumference of the screw flight for receiving, in particular fiber-containing, solids.

In step 103, determining the height of an already applied path in radial direction, wherein determining the height of the applied path in radial direction is performed by means of the following steps: placing the metal wire, which has a known length, on a reference plane, applying a metallic path by means of melting off the metal wire, placing the metal wire again on the reference plane for determination of the length of the metal wire, placing the metal wire on the applied path, determining the height of the applied path in dependence of the position of the metal wire when placing the metal wire on the applied path and of the length of the metal wire. Based on the determination of the actual height of an applied layer that is possible in this way, it is also possible to specify a nominal application height and to calculate the number of layers required to achieve this nominal application height.

In step 104, application of a metallic path by means of melting off a metal wire in a layer lying radially above the already applied path, wherein the positions at which the metal wire is melted off for application of this path is set in dependence of the previously determined height of the already applied path. In step 105, applying several layers arranged one above the other in radial direction, each with at least one path, until a nominal height is reached and/or exceeded, wherein preferably the height of at least one path of the previously applied layer in the radial direction is determined before applying each new layer.

In step 106, chip removal of additively applied material on the outer circumference of the screw flight for reduction of the roughness of the screw flight on the outer circumference of the screw flight and/or for production of a straight outer edge on the outer circumference of the screw flight. In step 107, chip removal of additively applied material on the flanks of the screw flight for reduction of the roughness of the screw flight on the flanks of the screw flight.

1-24. (canceled)

25. A screw conveyor for a separator device for dewatering moist masses, the screw conveyor comprising:
a shaft extending in an axial direction along an axis of rotation; and
a screw flight:
arranged helically around the shaft;
connected to the shaft at the outer circumference of the shaft; and
extending in the axial direction along at least a portion of the shaft;
wherein the screw flight is an additively manufactured metallic structure and has, on an outer circumference thereof, an outer edge in which is arranged at least one recess for receiving a fibrous material.

26. The screw conveyor according to claim 25, wherein the screw flight has a cross-sectional profile with a first width in the region of the outer circumference of the screw flight and a second width in the region of the inner circumference of the screw flight, and the first width in the region of the outer circumference of the screw flight is greater than the second width in the region of the inner circumference of the screw flight.

27. The screw conveyor according to claim 24, wherein the screw flight is produced by a wire-based additive manufacturing by means of arc welding, including gas metal arc welding (GMAW), including metal inert gas welding (MIG) and/or metal active gas welding (MAG).

28. The screw conveyor according to claim 24, wherein the screw flight is built up in layers, obtained by:
applying several metallic paths by means of melting off a metal wire, wherein the paths are arranged parallel to one another and run along a thread running direction of the screw flight.

29. The screw conveyor according to claim 24, wherein the screw flight is built up in layers, obtained by:
applying a first metallic path by means of melting off a metal wire, wherein the path runs along a thread running direction of the screw flight, and applying at least a second metallic path arranged parallel to the first metallic path and arranged in a first layer with the first metallic path;
determining the height of the first or second metallic path in a radial direction;
applying a third metallic path by means of melting off a metal wire in a second layer lying radially above the first layer, wherein the positions at which the metal wire is melted off for the application of this third metallic path is carried out in dependence of the previously determined height of the first or second metallic path; and
applying several layers arranged one above the other in the radial direction, each having at least one metallic path, to form a layer stack until the layer stack reaches and/or exceeds a nominal height, wherein before the application of each new layer the height of at least one path of the previously applied layer in the radial direction is determined.

30. The screw conveyor according to claim 24, wherein the screw conveyor has at least two screw flights arranged offset from one another in a circumferential direction in regular intervals defined by 360° divided by the number of screw flights, and are of uniform design; and
wherein each of the screw flights has a plurality of recesses in the circumferential direction and the recesses of one screw flight are offset in the axial direction from the recesses of another screw flight.

31. The screw conveyor according to claim 30, wherein in the screw flight in the circumferential direction within an angular range of 360° at least one recess is arranged; or
each screw flight has several spaced recesses and the recesses each have a longitudinal extension along a recess longitudinal axis, wherein the recess longitudinal axis is oriented obliquely, at an angle of at least 2.5°, relative to a thread running direction of the screw flight, so that compared to the thread running direction of the screw flight the recess longitudinal axis is oriented further in the direction of the axial direction.

32. The screw conveyor according to claim 30, wherein each screw flight has several spaced recesses;
the recesses each have a length in a thread running direction of the screw flight and a width in a width direction of the screw flight, and the length is at least twice as great as the width, wherein the length of the recesses is at least half as long as the distance between the recesses; or
the length of the recesses and the distance between the recesses are selected such that, during one full rotation of the screw conveyor about the axis of rotation, each point of a surface of rotation spanned by the outer circumference of the screw flight is swept by at least one of the recesses; or
the recesses are arranged at a uniform distance from each other in the circumferential direction on the screw flight; or
the recesses each have an opening in the outer edge of the screw flight, wherein the opening has a contour with at least two, acute angles, with an angle less than 90°.

33. The screw conveyor according to claim 24, wherein a cross-sectional profile of the screw flight has a negative flank angle on at least one side in at least one section, in the form of a linear course of the cross-sectional profile side or in the form of a course of a continuous function such as a parabola; and
the screw flight has an inner diameter and an outer diameter and the screw flight is formed wider in the region of the outer diameter than in the region of the inner diameter, wherein the screw flight is formed at least twice as wide in the region of the outer diameter as in the region of the inner diameter.

34. The screw conveyor according to claim 24, wherein the screw conveyor has an envelope which tapers from a first end of the screw conveyor to a second end of the screw conveyor.

35. A separator device for dewatering moist masses, including liquid manure and/or digestates, comprising:
a drive shaft rotatably mounted about a drive axis of rotation;
a screw conveyor according to claim 24, wherein the screw conveyor is connected to the drive shaft for torque transmission from the drive shaft to the screw conveyor; and
a screening device enclosing at least part of the screw conveyor, wherein the screening device has a liquid-permeable screen wall for dewatering the moist mass.

36. The separator apparatus according to claim 35, wherein a cross-sectional profile of the screw flight has a negative flank angle on at least one side in at least one section, in the form of a linear course of the cross-sectional profile side or in the form of a course of a continuous function such as a parabola; and
the screw flight has an inner diameter and an outer diameter and the screw flight is formed wider in the region of the outer diameter than in the region of the inner diameter, wherein the screw flight is formed at least twice as wide in the region of the outer diameter as in the region of the inner diameter; and
wherein the screening device extends from a first end to a second end and has an inner wall which is rotationally symmetrical about the drive axis of rotation, whose inner diameter tapers from the first end to the second end, wherein the screw conveyor is axially adjustable relative to the screening device by means of an axial adjustment device.

37. A method for manufacturing a screw conveyor according to claim 24, the method comprising the steps of:
providing a shaft which extends in an axial direction along an axis of rotation as a machined or preformed shaft;
performing additive manufacturing of a screw flight on the shaft by layer-by-layer material deposition, comprising:
applying a metallic path by means of melting a metal material, wherein the path extends along a thread running direction of the screw flight; and
applying further paths, which are arranged parallel to the applied path.

38. The method according to claim 37, wherein the screw flight is built up in layers such that the screw flight has a cross-sectional profile with a width in the region of the outer circumference of the screw flight and a width in the region of the inner circumference of the screw flight and the width in the region of the outer circumference of the screw flight is greater than the width in the region of the inner circumference of the screw flight; and
the screw flight is built up in layers in such a way that the screw flight has, on the outer circumference of the screw flight, several recesses spaced apart from one another for receiving fiber-containing solids.

39. The method according to claim 37, further comprising the steps of:
determining the height of an already applied path in a radial direction;
applying a metallic path by means of melting a metal material in a layer lying radially above the already applied path, wherein the positions at which the metal material is melted off for application of this path is set in dependence of the previously determined height of the already applied path; and
applying several layers arranged one above the other in the radial direction, each having at least one path, to form a layer stack until the layer stack reaches and/or exceeds a nominal height, wherein before the application of each new layer the height of at least one path of the previously applied layer in radial direction is determined.

40. The method according to claim 39, wherein the determination of the height of the applied path in the radial direction is performed by means of the following steps:
placing a surface of a welding head or a metal wire protruding from a welding head and, which has a known length, on the surface of the applied path, by detecting a contact force or detecting an electrical connection between the welding head or the metal wire and the applied path; and
determining the position of the surface of the deposited path in dependence of the position of the welding head when placing the metal wire on the applied path or a length of the metal wire.

41. The method according to claim 39, wherein the determination of the height of the applied path in radial direction is performed by means of the following steps:
placing a surface of a welding head or a metal wire protruding from a welding head, which has a known length, on a reference plane;
applying a metallic path by means of melting off the metal wire;
if necessary, again placing the metal wire protruding from the welding head on the reference plane for determination of the length of the metal wire;
placing the surface of the welding head or the metal wire on the surface of the applied path and detection of the placement of the surface of the welding head or the metal wire on the surface, by detecting a contact force or detecting an electrical connection between the surface of the welding head or the metal wire and the applied path; and
determining the position of the surface of the applied path in dependence of the position of the welding head during placing of the surface of the welding head or the metal wire on the applied path or a length of the metal wire.

42. The method according to claim 37, wherein the manufacture of the screw conveyor takes place by wire-based additive manufacturing by means of arc welding, including gas metal arc welding (GMAW), metal inert gas welding (MIG), and/or metal active gas welding (MAG), by means of at least one welding robot.

43. The method according to claim 42, further comprising the steps of:
chip removal of additively applied material at the outer circumference of the screw flight for reduction of the roughness of the screw flight at the outer circumference of the screw flight and/or for production of a straight outer edge at the outer circumference of the screw flight; and
chip removal of additively applied material on the flanks of the screw flight for reduction of the roughness of the screw flight on the flanks of the screw flight.

44. The method according to claim 42, wherein the shaft is clamped in a holder and is rotatable about the axis of rotation by means of movement of the holder; and
the at least one welding robot has at least two electromechanically driven axes.

45. The method according to claim 42, wherein the layered buildup of the screw flight is carried out by application of paths arranged in parallel, wherein the paths run along a thread running direction of the screw flight, wherein a part of the paths is formed continuously along the entire screw flight in each case, a part of the paths has interruptions in each case in the region of the recesses and is not formed continuously along the entire screw flight, or a recess is formed by the course of the paths.

46. The method according to claim 37, wherein the number of parallel paths in the inner diameter of the screw flight is less than the number of parallel paths in the area of the outer diameter of the screw flight.

47. The method according to claim 37, further comprising the step of:
creating production data for the positioning of the melting off of the metal wire when applying the path, comprising the steps:
creating a digital basic structure mapping cross-sectional information comprising a nominal height and a width dependent on the height of a screw flight; and
replicating the digital basic structure in a predetermined threading motion that corresponds to the thread shape of the screw flight.

48. A use of a screw conveyor according to claim 24, in a separator device, for dewatering moist masses, including digestates and/or liquid manure, wherein a cross-sectional profile of the screw flight has a negative flank angle on at least one side in at least one section, in the form of a linear course of the cross-sectional profile side or in the form of a course of a continuous function such as a parabola; and
the screw flight has an inner diameter and an outer diameter and the screw flight is formed wider in the region of the outer diameter than in the region of the inner diameter, wherein the screw flight is formed at least twice as wide in the region of the outer diameter as in the region of the inner diameter.
